(19) United States
(12) Patent Application Publication
(10) Pub. No.: US 2026/0054887 A1
(43) Pub. Date: Feb. 26, 2026

(54) Vessel closure with sealing element, vessel with vessel closure and method for producing a closed vessel

(71) Applicant: SILGAN HOLDINGS INC., Stamford, CT (US)

(72) Inventors: Juergen KINTSCHER, Wedemark (DE); Andreas MANIERA, Neustadt (DE)

(21) Appl. No.: 19/105,626

(22) PCT Filed: Aug. 18, 2023
(86) PCT No.: PCT/IB2023/058275

§ 371 Date: Feb. 21, 2025

(30) Foreign Application Priority Data
Aug. 21, 2022 (EP) 22191353.6

(51) Int. Cl. B65D 41/04; B65B 3/04; B65B 7/28; C08L 23/0807; C08L 23/20

(52) U.S. Cl. CPC B65D 41/0428; B65B 3/04; B65B 7/2835; C08L 23/0815; C08L 23/0823; C08L 23/20; C08L 2205/025

(57) ABSTRACT

The invention relates to a vessel closure with a sealing element. The sealing element comprises a polymer composition. The polymer composition comprises at least 1 wt.-% of a cyclic olefin polymer. The oxygen transmission rate—OTR—of the polymer composition, determined according to DIN 53380, is at most 3000 cm³ m⁻² d⁻¹ bar⁻¹.

The invention relates to a vessel closure with a sealing element, a vessel with the vessel closure and a method for producing a closed vessel.

Vessel closures with sealing element are known from the prior art. In particular, polymer compositions for the sealing element which contain no PVC or which contain further polymeric components in addition to PVC are relatively cost-intensive and the processing of the polymer composition is relatively difficult.

It is often disadvantageous if oxygen reaches a vessel which is closed and filled with a vessel closure to a relatively large extent, especially if the filling material is a foodstuff. Sealing elements consisting of PVC offer good protection against such penetration of oxygen into a vessel. Sealing elements with low PVC content often achieve this only inadequately. Therefore, oxygen scavengers are often used in polymer compositions with low PVC content for the sealing elements.

An example of an oxygen scavenger is sodium sulfite. Here, sodium sulfite is often undesirable in compositions for sealing elements of vessel closures, since this sulfite salt can pass into the filling material and can cause allergy-like reactions in consumers.

It is an object of the invention to provide a vessel closure with a sealing element, wherein the sealing element can be produced at acceptable costs and the sealing element has low or very low oxygen permeability values.

It is a further object to provide a vessel closure with a sealing element which can be sterilized when the vessel closure closes a vessel.

It is a still further object to provide a vessel closure with a sealing element, wherein the sealing element has low overall migration.

At least one of the objects is solved by the subject matter of the independent claims.

A vessel closure with a sealing element is disclosed. The sealing element comprises a polymer composition. The polymer composition can comprise at least 1 wt.-% of a cyclic olefin polymer.

Alternatively or additionally, the polymer composition can have an oxygen transmission rate, determined according to DIN 53380, of at most 3000 cm³ m⁻² d⁻¹ bar⁻¹.

Generally, wt.-% (percent by weight) data relate to the total weight of all components of a mixture or composition. For example, wt.-% data of components of the polymer composition relate to all components of the polymer composition.

The sealing element may be substantially disk-shaped or substantially ring-shaped.

The sealing element may have a thickness (in the axial direction of the vessel closure and/or in the axial direction of the vessel) of at least 0.5 mm, preferably at least 1.0 mm, more preferably at least 1.5 mm, more preferably at least 2.0 mm.

The sealing element may have a diameter (perpendicular to the axial direction of the vessel closure and/or perpendicular to the axial direction of the vessel) of at most 300 mm, preferably at most 250 mm, more preferably at most 200 mm, more preferably at most 150 mm, more preferably at most 120 mm. The diameter of the sealing element may be at least 5 mm, preferably at least 10 mm, more preferably at least 15 mm, more preferably at least 20 mm. Particularly preferably, the sealing element has a diameter between 10 mm and 200 mm, in particular between 15 mm and 130 mm.

The polymer composition may make up a large part of the sealing element. The sealing element may comprise further constituents in addition to the polymer composition. The further constituents may be polymeric constituents or non-polymeric constituents. For example, the sealing element may comprise one or more films. The film may be a polymeric or a non-polymeric film, preferably the film is a metal film. In particular, the sealing element consists of the polymer composition.

A cyclic olefin polymer is a polymer which is produced from at least one cyclic (olefinic) monomer. The at least one cyclic monomer may be copolymerized with a further monomer, in particular with a non-cyclic monomer. The further monomer may be an olefin, in particular an alpha-olefin. The cyclic olefin polymer may likewise be produced by a ring-opening polymerization of at least one cyclic (olefinic) monomer. After the polymerization of the at least one cyclic (olefinic) monomer, the polymer may be hydrogenated.

The cyclic olefin polymer may not have segments obtained from styrene. No styrene may have been used as (co)monomer for the polymerization of the cyclic olefin polymer.

The cyclic olefin polymer may contain no aromatic group. The cyclic olefin polymer may be free of one or more aromatic groups.

The cyclic olefin polymer may be uncrosslinked. The cyclic olefin polymer may have no chemical crosslinking.

The cyclic olefin polymer may comprise no propylene as comonomer. Propylene may not have been used as comonomer in the production of the cyclic olefin polymer. The cyclic olefin polymer may comprise no units obtained from propylene.

The cyclic olefin polymer may be no EPDM (ethylene-propylene-diene rubber) with a cyclic comonomer. The cyclic olefin polymer may be no EPDM (ethylene-propylene-diene rubber). In particular, ethylene-norbornene is not a comonomer of the cyclic olefin polymer.

The polymer composition may comprise a maximum of 20 wt.-% of EPDM, preferably a maximum of 15 wt.-% of EPDM, more preferably a maximum of 10 wt.-% of EPDM, more preferably a maximum of 5 wt.-% of EPDM, more preferably a maximum of 1 wt.-% of EPDM.

Preferably, the polymer composition comprises no EPDM. The polymer composition may be free of EPDM.

In the cyclic olefin polymer, at least one ring (cycle) may be integrated or contained in the main chain or the backbone of the cyclic olefin polymer. The ring (cycle) may be covalently bonded in the main chain or the backbone. The main chain or the backbone may be the longest series of covalently bonded atoms. The main chain or the backbone may form the continuous chain of the polymer.

Exactly one monomer or at most one monomer may have been used for the production of the cyclic olefin polymer.

Preferably, the cyclic olefin polymer comprises monocyclic units. The cyclic olefin polymer may comprise a monocyclic C5 unit. The monocyclic C5 unit may be a ring (cycle) having five carbon atoms.

The cyclic olefin polymer may have a light transmittance, determined according to ISO 13468-2, of at least 50%, preferably at least 60%, more preferably at least 70%, more preferably at least 75%, more preferably at least 80%, more preferably at least 82%, more preferably at least 85%, more preferably at least 87%, more preferably at least 90%, more preferably at least 92%, more preferably at least 95%.

The cyclic olefin polymer may have a water absorption, determined according to ISO 62, of at most 10%, preferably at most 9%, more preferably at most 8%, more preferably at most 7%, more preferably at most 6%, more preferably at most 5%, more preferably at most 4%, more preferably at most 3%, more preferably at most 2%, more preferably at most 1%, more preferably at most 0.5%, more preferably at most 0.2%, more preferably at most 0.1%, more preferably at most 0.05%.

The cyclic olefin polymer may have a Shore A hardness (determined according to DIN ISO 7619 at a temperature of 23° C. and a holding time of 15 s) of at least 40. Preferably, the Shore A hardness of the cyclic olefin polymer is at least 50, more preferably at least 60, more preferably at least 70, more preferably at least 80, more preferably at least 90.

The cyclic olefin polymer may have a Shore D hardness (determined according to DIN ISO 7619 at a temperature of 23° C. and a holding time of 15 s) of at least 20. Preferably, the Shore D hardness of the cyclic olefin polymer is at least 30, more preferably at least 40, more preferably at least 50, more preferably at least 60, more preferably at least 70, more preferably at least 75.

The Shore D hardness of the cyclic olefin polymer may be at most 90, preferably at most 80, more preferably at most 70, more preferably at most 60, more preferably at most 50. In particular, the Shore D hardness of the cyclic olefin polymer is between 70 and 85 or between 72 and 87.

The cyclic olefin copolymer may have a density (determined according to ISO 1183) of at least at least 0.850 g cm⁻³. Preferably, the density of the cyclic olefin polymer is at least 0.870 g cm⁻³, more preferably at least 0.890 g cm⁻³, more preferably at least 0.910 g cm⁻³, more preferably at least 0.930 g cm⁻³, more preferably at least 0.950 g cm⁻³, more preferably at least 0.970 g cm⁻³, more preferably at least 0.990 g cm⁻³, more preferably at least 1.000 g cm⁻³, more preferably at least 1.010 g cm⁻³.

The density of the cyclic olefin polymer is preferably between 0.900 g cm⁻³ and 1.100 g cm⁻³, more preferably between 0.920 g cm⁻³ and 1.050 g cm⁻³, more preferably between 0.930 g cm⁻³ and 1.030 g cm⁻³. More preferably, the density of the cyclic olefin polymer is between 0.930 g cm⁻³ and 0.950 g cm⁻³, or between 0.970 g cm⁻³ and 0.990 g cm⁻³, or between 1.000 g cm⁻³ and 1.020 g cm⁻³, or between 1.010 g cm⁻³ and 1.030 g cm⁻³.

The cyclic olefin copolymer may have a glass transition temperature (determined according to ISO 11357-1, -2, -3, 10° C./min) of at least −20° C. Preferably, the glass transition temperature of the cyclic olefin copolymer is at least 0° C., more preferably at least 3° C., more preferably at least 40° C., more preferably at least 60° C., more preferably at least 70° C., more preferably at least 90° C., more preferably at least 110° C., more preferably at least 125° C., more preferably at least 130° C., more preferably at least 150° C., more preferably at least 170° C.

The glass transition temperature of the cyclic olefin copolymer may be at most 200° C., preferably at most 190° C., more preferably at most 180° C., more preferably at most 170° C., more preferably at most 160° C., more preferably at most 150° C., more preferably at most 140° C., more preferably at most 120° C., more preferably at most 100° C., more preferably at most 80° C., more preferably at most 70° C., more preferably at most 50° C., more preferably at most 30° C., more preferably at most 10° C.

The glass transition temperature of the cyclic olefin copolymer may be between 1° C. and 11° C., or between 60° C. and 70° C., or between 73° C. and 83° C., or between 74° C. and 84° C., or between 130° C. and 140° C., or between 129° C. and 139° C., or between 133° C. and 143° C., or between 153° C. and 163° C., or between 173° C. and 183° C.

A monomer or a comonomer of the cyclic olefin polymer may be a monocyclic or polycyclic olefin. After the polymerization of the cyclic olefin polymer, the cyclic olefin polymer may comprise at least one monocyclic unit or polycyclic unit. The monocyclic unit or polycyclic unit may be formed by the monocyclic or polycyclic monomer or comonomer.

Preferably, the monomer or comonomer of the cyclic olefin polymer is a monocyclic or polycyclic C3 to C20 olefin. More preferably, the monomer or comonomer of the cyclic olefin polymer is a monocyclic or polycyclic C5 to C20 olefin. More preferably, the monomer or comonomer of the cyclic olefin polymer is a monocyclic or polycyclic C7 to C17 olefin, more preferably a monocyclic or polycyclic C7 to C12 olefin. More preferably, the monomer or comonomer of the cyclic olefin polymer is a monocyclic or polycyclic C7 olefin. For example, the monomer or comonomer of the cyclic olefin polymer is norbornene (bicyclo [2.2.1]hept-2-ene).

The monomer or comonomer of the cyclic olefin polymer may be a monocyclic or polycyclic alkene. The monomer or comonomer of the cyclic olefin polymer may be a monocyclic C3 to C8 olefin (mono-cyclopropene to mono-cyclooctene).

The monomer or comonomer of the cyclic olefin polymer may contain at least two rings (cycles). Preferably, the monomer or comonomer of the cyclic olefin polymer contains two to twenty, more preferably two to fifteen, more preferably two to ten, more preferably two to eight rings (cycles). The monomer or comonomer of the cyclic olefin polymer may be a bis- to octacyclo-olefin. Suitable monomers or comonomers of the cyclic olefin polymer are described on pages 4 to 17, in particular on pages 6, 7 and/or in Tables 1 and 2, of EP 0 283 164 A2, the content of which is incorporated by reference into the present disclosure.

The monomer or comonomer of the cyclic olefin polymer may be a homocyclic ring. Preferably, the monomer or comonomer of the cyclic olefin polymer is a carbon homocyclic ring.

The monomer or comonomer of the cyclic olefin polymer may be a heterocycle. The heterocycle may contain one or more heteroatoms. Preferably, the heterocycle contains nitrogen, oxygen and/or sulfur.

The monomer or comonomer of the cyclic olefin polymer may be unsubstituted or substituted. Preferably, the monomer or comonomer of the cyclic olefin polymer contains at least one of the following substituents: alkenyl, alkyl, hydroxyl, carboxyl, carboxyalkyl and halogen.

The cyclic olefin polymer may be unsubstituted or substituted. Preferably, the cyclic olefin polymer contains at least one of the following substituents: alkenyl, alkyl, hydroxyl, carboxyl, carboxyalkyl and halogen.

In general, some molecules (monomers or comonomers) are referred to herein according to the number of their carbon atoms. For example, a C5 olefin is an olefin having 5 carbon atoms and a C20 olefin is an olefin having 20 carbon atoms.

The cyclic olefin polymer may be produced by a ring-retaining or by a ring-opening polymerization. The ring-opening polymerization may be a ring-opening metathesis polymerization.

In a ring-retaining polymerization, one ring (cycle) or more rings (cycles) of a monomer may be present in the polymer after the polymerization. In other words, a ring (cycle) or more rings (cycles) of a monomer may not be opened by the polymerization.

In a ring-opening polymerization, one ring (cycle) or more rings (cycles) of a monomer may not be present in the polymer after the polymerization. In other words, a ring (cycle) or more rings (cycles) of a monomer may be opened by the polymerization.

Preferably, a ring (cycle) or more rings (cycles) are present in the polymer after the ring-opening polymerization. A monomer used for the polymerization may contain at least two rings (cycles). In particular, the monomer used for the polymerization contains exactly two rings (cycles) or at most two rings (cycles). One of the rings (cycles) may be opened by the polymerization. Another of the rings (cycles) may be present in the (polymerized) polymer. That is to say, at least one of the rings (cycles) may be opened during the polymerization and another of the rings (cycles) may be incorporated into the polymer or be present in the polymer.

A monocyclic or polycyclic olefin may have a fraction of at least 2 mol-% in the cyclic olefin polymer. Preferably, a monocyclic or polycyclic olefin has a fraction of at least 5 mol-%, more preferably of at least 10 mol-%, more preferably of at least 20 mol-%, more preferably of at least 40 mol-%, more preferably of at least 60 mol-%, more preferably of at least 65 mol-%, in the cyclic olefin polymer.

A monocyclic or polycyclic olefin may have a fraction of at most 90 mol-% in the cyclic olefin polymer. Preferably, a monocyclic or polycyclic olefin has a comonomer fraction of at most 75 mol-%, more preferably of at most 60 mol-%, more preferably of at most 50 mol-%, more preferably of at most 40 mol-%, in the cyclic olefin polymer.

The fraction of a monocyclic or polycyclic olefin in the cyclic olefin polymer may be between 25 mol-% and 35 mol-%, or between 45 mol-% and 55 mol-%, or between 60 mol-% and 70 mol-%, or between 60 mol-% and 90 mol-%, in particular between 70 mol-% and 80 mol-%.

In particular, the cyclic olefin polymer is a cyclic olefin copolymer. The cyclic olefin copolymer may be produced from at least two different monomers. Preferably, the cyclic olefin copolymer is a cyclic olefin bipolymer. In a cyclic olefin bipolymer, exactly two different types of monomers were used for the polymerization.

A comonomer of the cyclic olefin copolymer may be a C2- to C10-(alpha)olefin. Preferably, a comonomer of the cyclic olefin copolymer is a C2- to C8-(alpha)olefin, more preferably a C2- to C6-(alpha)olefin. A comonomer of the cyclic olefin copolymer may be ethene, alpha-butene or alpha-hexene. Most preferably, a comonomer of the cyclic olefin copolymer is ethene. The comonomer may be referred to as a non-cyclic comonomer.

A monocyclic or polycyclic olefin as a comonomer of the cyclic olefin copolymer may have a comonomer fraction of at least 2 mol-%. Preferably, a monocyclic or polycyclic olefin as a comonomer of the cyclic olefin copolymer has a comonomer fraction of at least 5 mol-%, more preferably of at least 10 mol-%, more preferably of at least 20 mol-%, more preferably of at least 40 mol-%, more preferably of at least 60 mol-%, more preferably of at least 65 mol-%.

A monocyclic or polycyclic olefin as a comonomer of the cyclic olefin copolymer may have a comonomer fraction of at most 90 mol-%. Preferably, a monocyclic or polycyclic olefin as a comonomer of the cyclic olefin copolymer has a comonomer fraction of at most 75 mol-%, more preferably of at most 60 mol-%, more preferably of at most 50 mol-%, more preferably of at most 40 mol-%.

The comonomer fraction of a monocyclic or polycyclic olefin as a comonomer of the cyclic olefin copolymer may be between 25 mol-% and 35 mol-%, or between 45 mol-% and 55 mol-%, or between 60 mol-% and 70 mol-%, or between 60 mol-% and 90 mol-%, in particular between 70 mol-% and 80 mol-%.

The non-cyclic comonomer of the cyclic olefin copolymer may have a comonomer fraction of at most 90 mol-%, preferably of at most 80 mol-%, more preferably of at most 60 mol-%, more preferably of at most 40 mol-%, more preferably of at most 35 mol-%. The non-cyclic comonomer may be any non-cyclic comonomer disclosed herein and in particular a non-cyclic comonomer described in more detail above. For example, the non-cyclic comonomer is a C2- to C10-(alpha)olefin, more preferably ethene.

The non-cyclic comonomer of the cyclic olefin copolymer may have a comonomer fraction of at least 10 mol-%, preferably of at least 25 mol-%, more preferably of at least 40 mol-%, more preferably of at least 60 mol-%, more preferably of at least 65 mol-%. The non-cyclic comonomer may be any non-cyclic comonomer disclosed herein and in particular a non-cyclic comonomer described in more detail above. For example, the non-cyclic comonomer is a C2- to C10-(alpha)olefin, more preferably ethene.

The non-cyclic comonomer of the cyclic olefin copolymer may have a comonomer fraction of between 65 mol-% and 75 mol-%, or between 45 mol-% and 55 mol-%, or between 30 mol-% and 40 mol-%, or between 10 mol-% and 40 mol-%, in particular between 20 mol-% and 30 mol-%.

The non-cyclic comonomer may be any non-cyclic comonomer disclosed herein and in particular a non-cyclic comonomer described in more detail above. For example, the non-cyclic comonomer is a C2- to C10-(alpha)olefin, more preferably ethene.

A monocyclic or polycyclic olefin as a comonomer of the cyclic olefin copolymer may have a comonomer fraction of at least 10 wt.-%. Preferably, a monocyclic or polycyclic olefin as a comonomer of the cyclic olefin copolymer has a comonomer fraction of at least 20 wt.-%, more preferably of at least 25 wt.-%, more preferably of at least 40 wt.-%, more preferably of at least 50 wt.-%, more preferably of at least 60 wt.-%, more preferably of at least 70 wt.-%, more preferably of at least 80 wt.-%.

A monocyclic or polycyclic olefin as a comonomer of the cyclic olefin copolymer may have a comonomer fraction of at most 95 wt.-%. Preferably, a monocyclic or polycyclic olefin as a comonomer of the cyclic olefin copolymer has a comonomer fraction of at most 90 wt.-%, more preferably of at most 80 wt.-%, more preferably of at most 70 wt.-%, more preferably of at most 60 wt.-%, more preferably of at most 50 wt.-%, more preferably of at most 40 wt.-%, more preferably of at most 35 wt.-%.

The comonomer fraction of a monocyclic or polycyclic olefin as a comonomer of the cyclic olefin copolymer may be between 25 wt.-% and 35 wt.-%, or between 45 wt.-% and 55 wt.-%, or between 60 wt.-% and 70 wt.-%, or between 70 wt.-% and 80 wt.-%, or between 72 wt.-% and 82 wt.-%, or between 78 wt.-% and 88 wt.-%, or between 81 wt.-% and 91 wt.-%.

The non-cyclic comonomer of the cyclic olefin copolymer may have a comonomer fraction of at most 90 wt.-%, preferably of at most 80 wt.-%, more preferably of at most 70 wt.-%, more preferably of at most 60 wt.-%, more preferably of at most 50 wt.-%, more preferably of at most 40 wt.-%, more preferably of at most 30 wt.-%, more preferably of at most 28 wt.-%, more preferably of at most 22 wt.-%, more preferably of at most 19 wt.-%. The non-cyclic comonomer may be any non-cyclic comonomer disclosed herein and in particular a non-cyclic comonomer described in more detail above. For example, the non-cyclic comonomer is a C2- to C10-(alpha)olefin, more preferably ethene.

The non-cyclic comonomer of the cyclic olefin copolymer may have a comonomer fraction of at least 5 wt.-%, preferably of at least 9 wt.-%, more preferably of at least 12 wt.-%, more preferably of at least 18 wt.-%, more preferably of at least 20 wt.-%, more preferably of at least 30 wt.-%, more preferably of at least 40 wt.-%, more preferably of at least 45 wt.-%, more preferably of at least 50 wt.-%, more preferably of at least 60 wt.-%, more preferably of at least 65 wt.-%. The non-cyclic comonomer may be any non-cyclic comonomer disclosed herein and in particular a non-cyclic comonomer described in more detail above. For example, the non-cyclic comonomer is a C2- to C10-(alpha)olefin, more preferably ethene.

The non-cyclic comonomer of the cyclic olefin copolymer may have a comonomer fraction of between 9 wt.-% and 19 wt.-%, or between 12 wt.-% and 22 wt.-%, or between 18 wt.-% and 28 wt.-%, or between 20 wt.-% and 30 wt.-%, or between 30 wt.-% and 40 wt.-%, or between 45 wt.-% and 55 wt.-%, or between 65 wt.-% and 75 wt.-%. The non-cyclic comonomer may be any non-cyclic comonomer disclosed herein and in particular a non-cyclic comonomer described in more detail above. For example, the non-cyclic comonomer is a C2- to C10-(alpha)olefin, more preferably ethene.

For example, the cyclic olefin copolymer is an ethene-norbornene copolymer, in particular an ethene-norbornene bipolymer.

The cyclic olefin polymer may be present in the polymer composition in an amount of at least 5 wt.-%. Preferably, the cyclic olefin polymer is present in the polymer composition in an amount of at least 10 wt.-%, more preferably at least 15 wt.-%, more preferably at least 20 wt.-%, more preferably at least 25 wt.-%, more preferably at least 30 wt.-%, more preferably at least 35 wt.-%, more preferably at least 40 wt.-%, more preferably at least 45 wt.-%, more preferably at least 50 wt.-%, more preferably at least 55 wt.-%, more preferably at least 60 wt.-%, more preferably at least 65 wt.-%, more preferably at least 70 wt.-%, more preferably at least 75 wt.-%, more preferably at least 80 wt.-%, more preferably at least 85 wt.-%, more preferably at least 90 wt.-%, more preferably at least 95 wt.-%.

The cyclic olefin polymer may be present in the polymer composition in an amount of at most 95 wt.-%. Preferably, the cyclic olefin polymer is present in the polymer composition in an amount of at most 90 wt.-%, more preferably at most 85 wt.-%, more preferably at most 80 wt.-%, more preferably at most 75 wt.-%, more preferably at most 70 wt.-%, more preferably at most 65 wt.-%, more preferably at most 60 wt.-%, more preferably at most 55 wt.-%, more preferably at most 50 wt.-%, more preferably at most 45 wt.-%, more preferably at most 40 wt.-%, more preferably at most 35 wt.-%, more preferably at most 30 wt.-%, more preferably at most 25 wt.-%, more preferably at most 20 wt.-%, more preferably at most 15 wt.-%, more preferably at most 10 wt.-%, more preferably at most 5 wt.-%.

The cyclic olefin polymer may be present in the polymer composition in an amount of between 5 wt.-% and 90 wt.-%, preferably between 5 wt.-% and 80 wt.-%, more preferably between 5 wt.-% and 70 wt.-%, more preferably between 5 wt.-% and 60 wt.-%, more preferably between 5 wt.-% and 50 wt.-%, more preferably between 5 wt.-% and 40 wt.-%, more preferably between 10 wt.-% and 30 wt.-%, more preferably between 15 wt.-% and 30 wt.-%, more preferably between 20 wt.-% and 30 wt.-%, more preferably between 22 wt.-% and 26 wt.-%.

The cyclic olefin polymer may be present in the polymer composition in an amount of between 50 wt.-% and 95 wt.-%, preferably between 60 wt.-% and 95 wt.-%, more preferably between 65 wt.-% and 90 wt.-%, more preferably between 70 wt.-% and 90 wt.-%.

In particular, the cyclic olefin polymer is present in the polymer composition in an amount of between 70 wt.-% and 80 wt.-% or between 80 wt.-% and 90 wt.-%.

The polymer composition can comprise a further polymer. The further polymer may be present in the polymer composition in an amount of up to 95 wt.-%. Preferably, the further polymer is present in the polymer composition in an amount of between 1 wt.-% and 95 wt.-%.

For example, the cyclic olefin polymer is a first polymer in the polymer composition and the further polymer is a second polymer in the polymer composition. The polymer composition may comprise at least two (different or different types of) polymers, preferably at least three (different or different types of) polymers, more preferably at least four (different or different types of) polymers.

In general, a polymer disclosed herein may be solid or liquid at 23° C. and 1 bar (solid or liquid state of aggregation), in particular a polymer disclosed herein is solid at 23° C. and 1 bar.

The further polymer of the polymer composition can be a copolymer, in particular a random copolymer or a block copolymer. The further polymer may be a polyolefin.

Preferably, ethene is a comonomer of the further polymer as a copolymer. Alternatively or additionally, at least one C3 to C16 (alpha-)olefin may be a comonomer of the copolymer.

Preferably, ethene is a comonomer of the copolymer and at least one C3 to C16 (alpha-)olefin is a comonomer of the copolymer. More preferably, ethene is a comonomer of the copolymer and at least one C3 to C8 (alpha-)olefin is a comonomer of the copolymer. More preferably, ethene is a comonomer of the copolymer and at least one of propene, alpha-butene, alpha-pentene, alpha-hexene, alpha-heptene and alpha-octene is a comonomer of the copolymer. More preferably, ethene is a comonomer of the copolymer and alpha-butene or alpha-octene is a comonomer of the copolymer.

The further polymer as a copolymer may be a bipolymer.

The further polymer of the polymer composition may be a homopolymer. The further polymer may be a C2 to C4 homopolymer. For example, the further polymer may be homo-polyethene (HDPE or LDPE). Likewise, the further polymer may be homopropene. The further polymer may be homo-alpha-polybutene.

If the further polymer comprises ethene as a comonomer, the comonomer fraction of ethene in the further polymer may be more than 30 mol-%, preferably more than 40 mol-%, more preferably more than 50 mol-%, more preferably more than 55 mol-%, more preferably more than 60 mol-%, more preferably more than 70 mol-%, more preferably more than 80 mol-%, more preferably more than 90 mol-%.

The further polymer as a copolymer may be an ethene-alpha-octene copolymer, in particular an ethene-alpha-octene block copolymer.

The comonomer fraction of ethene in the further polymer may be less than 90 mol-%, preferably less than 80 mol-%, more preferably less than 70 mol-%, more preferably less than 60 mol-%, more preferably less than 50 mol-%, more preferably less than 40 mol-%, more preferably less than 30 mol-%, more preferably less than 20 mol-%, more preferably less than 10 mol-%.

The further polymer as a copolymer may be an alpha-butene-ethene copolymer, in particular an alpha-butene-ethene random copolymer.

The polymer composition can comprise a further cyclic olefin polymer. The further cyclic olefin polymer may be the further polymer of the polymer composition.

The polymer composition may thus comprise at least two different cyclic olefin polymers. The two different cyclic olefin polymers may differ by at least one chemical and/or by at least one physical property.

For example, different cyclic olefin polymers may differ by their monomers. If the cyclic olefin polymers are cyclic olefin copolymers, different cyclic olefin copolymers may differ by different comonomers. Likewise, different cyclic olefin copolymers may differ by different comonomer fractions. For example, different cyclic olefin copolymers may be constructed from the same comonomers, but at least one of the comonomers in a cyclic olefin copolymer may have a different comonomer fraction than in a further cyclic olefin copolymer.

The further cyclic olefin polymer may be any cyclic olefin polymer disclosed herein.

The further cyclic olefin polymer may be present in the polymer composition in an amount of at most 80 wt.-%, preferably at most 70 wt.-%, more preferably at most 60 wt.-%, more preferably at most 50 wt.-%, more preferably at most 40 wt.-%, more preferably at most 30 wt.-%. The further cyclic olefin polymer may be present in the polymer composition in an amount of at least 1 wt.-%, preferably at least 3 wt.-%, more preferably at least 5 wt.-%, more preferably at least 10 wt.-more preferably at least 15 wt.-%, more preferably at least 20 wt.-%.

The further cyclic olefin polymer may be present in the polymer composition in an amount of between 1 wt.-% and 80 wt.-%, preferably between 1 wt.-% and 50 wt.-%, more preferably between 3 wt.-% and 50 wt.-%, more preferably between 3 wt.-% and 40 wt.-%, more preferably between 5 wt.-% and 40 wt.-%, more preferably between 10 wt.-% and 35 wt.-%, more preferably between 15 wt.-% and 35 wt.-%, more preferably between 20 wt.-% and 30 wt.-%, more preferably between 22 wt.-% and 26 wt.-%.

The polymer composition may contain less than 10 wt.-% polyvinyl chloride (PVC). Preferably, the polymer composition contains less than 2 wt.-% PVC, more preferably the polymer composition is free of PVC (within the scope of the analytical accuracy at the filing date).

The polymer composition may contain at least 1 wt.-% PVC. Preferably, the polymer composition contains at least 2 wt.-%, more preferably at least 5 wt.-%, more preferably at least 10 wt.-%, more preferably at least 20 wt.-%, more preferably at least 30 wt.-% PVC. The further polymer of the polymer composition may be PVC.

The polymer composition may not comprise an oxygen scavenger. The polymer composition may be free of an oxygen scavenger. In particular, the polymer composition contains no sodium sulfite or is free of sodium sulfite.

The polymer composition may not comprise an SEBS (styrene-ethylene-butylene-styrene). The polymer composition may be free of SEBS. In particular, the polymer composition contains no styrene-containing component or is free of a styrene-containing component.

The polymer composition may contain at least 1 wt.-% of a component that is liquid at 20° C. and 1 bar. Preferably, the polymer composition contains at least 5 wt.-%, more preferably at least 10 wt.-%, more preferably at least 15 wt.-%, more preferably at least 20 wt.-% of a component that is liquid at 20° C. and 1 bar.

The component that is liquid at 20° C. and 1 bar may be present in the polymer composition in an amount of between 1 wt.-% and 60 wt.-%, preferably between 1 wt.-% and 45 wt.-%, more preferably between 1 wt.-% and 30 wt.-%, more preferably between 5 wt.-% and 30 wt.-%, more preferably between 5 wt.-% and 15 wt.-% or between 15 wt.-% and 25 wt.-%.

The liquid component may be the further polymer of the polymer composition. Alternatively, the liquid component may be present in the polymer composition in addition to the further polymer.

The liquid component may be a polyalphaolefin. The liquid component may have a kinematic viscosity, determined according to ASTM D445/ISO 3104, of at least 4 cSt at a temperature of 100° C. Alternatively or additionally, the liquid component may have a dropping point, determined according to ASTM 5950, of at most −10° C.

The kinematic viscosity of the liquid component at a temperature of 100° C., determined according to ASTM D445/ISO 3104, may be between 4 cSt and 1500 cSt, preferably between 50 cSt and 1000 cSt, more preferably between 120 cSt and 1000 cSt, even more preferably between 250 cSt and 1000 cSt.

The kinematic viscosity of the liquid component at a temperature of 100° C. may also be between 2 cSt and 10 cSt, between 55 cSt and 75 cSt, between 140 cSt and 160 cSt, between 280 cSt and 320 cSt or between 900 cSt and 1100 cSt.

The dropping point of the liquid component may be at most −20° C. or at most 30° C.

The liquid component may have a density, determined according to ASTM D4052, of up to 0.860 g cm⁻³, in particular between 0.825 g cm⁻³ and 0.855 g cm⁻³. The density of the liquid component may also be between 0.840 g cm⁻³ and 0.855 g cm⁻³.

The liquid component may have an average molecular weight Mw, determined according to DIN 55672-1, of at least 440 Da, preferably between 440 Da and 12000 Da, particularly preferably between 1000 Da and 10000 Da, even more preferably between 3000 Da and 10000 Da.

The liquid component may be a metallocene component. The liquid component may have been produced by the use of a metallocene catalyst.

The liquid component may be a Ziegler-Natta component. The liquid component may have been produced by the use of a Ziegler-Natta catalyst.

The liquid component may be a homopolymer or a copolymer.

The liquid component may be a homopolymer of a C3 to C22 alpha-olefin. For the production of the liquid component as homopolymer, alpha-olefins with a length of C3 to C22 are thus used as monomers. Preferably, C6 to C14 alpha-olefins or C8 to C10 alpha-olefins are used as monomers for the liquid component as homopolymer.

The liquid component may be an alpha-octene homopolymer or an alpha-decene homopolymer, preferably an alpha-decene homopolymer.

As copolymer, the liquid component is constructed from at least two different alpha-olefins with a length of C3 to C22 as comonomers. Specifically, two different alpha-olefins with a length of C6 to C14 or C8 to C10 are used as comonomers.

The liquid component may be a bipolymer.

The liquid component may be a synthetic fluid (at 23° C. and 1 bar), in particular the liquid component is a completely synthetic fluid (at 23° C. and 1 bar).

The liquid component may be hydrogenated, in particular the liquid component is completely hydrogenated.

The liquid component may be a mixture of different liquid components. For example, the liquid component may be a mixture of at least two liquid components which differ in their kinematic viscosity and/or in their (co-)monomers. To this end, at least two of the liquid components disclosed herein may be present as a mixture.

The liquid component may be or comprise a polyalphaolefin. The liquid component may be a mixture of different polyalphaolefins.

The polymer composition may contain at most one polymeric component or exactly one polymeric component. The at most one polymeric component may be the cyclic olefin polymer. In other words, the polymer composition may contain no further polymer in addition to the cyclic olefin polymer. Thus, exactly one polymer (exactly one polymer type) may be present in the polymer composition. In addition, the polymer composition may contain non-polymeric components. The non-polymeric components may be additives, non-polymeric liquid components, etc.

In particular, the cyclic olefin polymer is present in the polymer composition in an amount of at least 80 wt.-%, preferably at least 85 wt.-%, more preferably at least 88 wt.-%, more preferably at least 90 wt.-%, more preferably at least 92 wt.-%, more preferably at least 94 wt.-%, more preferably at least 95 wt.-%.

The cyclic olefin copolymer may be present in the polymer composition in an amount of at most 99 wt.-%. Preferably, the cyclic olefin copolymer is present in the polymer composition in an amount of at most 98 wt.-%, more preferably at most 97 wt.-%, more preferably at most 96 wt.-%.

The cyclic olefin copolymer may be present in the polymer composition in an amount of between 80 wt.-% and 100 wt.-%, preferably between 80 wt.-% and 99 wt.-%, more preferably between 85 wt.-% and 99 wt.-%, more preferably between 85 wt.-% and 98 wt.-%, more preferably between 90 wt.-% and 98 wt.-%, more preferably between 92 wt.-% and 98 wt.-%, more preferably between 94 wt.-% and 98 wt.-%, more preferably between 95 wt.-% and 97 wt.-%.

The polymer composition may contain less than 10 wt.-% of a component that is liquid at 20° C. and 1 bar. In particular, the polymer composition contains less than 5 wt.-%, more preferably less than 2 wt.-% of a component that is liquid at 20° C. and 1 bar. Most preferably, the polymer composition is free of a component that is liquid at 20° C. and 1 bar (within the scope of the analytical accuracy at the filing date).

The polymer composition may contain less than 10 wt.-% white oil. In particular, the polymer composition contains less than 5 wt.-%, more preferably less than 2 wt.-% white oil. Most preferably, the polymer composition is free of white oil (within the scope of the analytical accuracy at the filing date).

The polymer composition may comprise a liquid component, for example polyalphaolefin (as described above) and/or comprise little or no white oil.

The polymer composition may comprise up to 15 wt.-%, preferably up to 8 wt.-%, more preferably up to 6 wt.-%, most preferably up to 5 wt.-%, additives.

Additives in the polymer composition may be selected from the group consisting of: pigments, nucleating agents, brighteners, stabilizers, surfactants, lubricants, antioxidants and combinations thereof.

The polymer composition may have a Shore A hardness, determined according to DIN ISO 7619 at a temperature of 23° C. and a holding time of 15 s, of at least 40. Preferably, the polymer composition has a Shore A hardness of at least 50, more preferably at least 60, more preferably at least 70, more preferably at least 80.

The Shore A hardness of the polymer composition may be between 40 and 100, preferably between 40 and 95, more preferably between 50 and 95, more preferably between 60 and 95, more preferably between 65 and 95.

The polymer composition may have a Shore D hardness, determined according to DIN ISO 7619 at a temperature of 23° C. and a holding time of 15 s, of less than 80. In particular, the polymer composition has a Shore D hardness of less than 70, more preferably less than 60, more preferably less than 50.

The polymer composition may have a compression set, determined according to ASTM D 395, 70° C., 22 h, of at least 50%. In particular, the polymer composition has a compression set of at least 60%, more preferably at least 70%, more preferably at least 80%, more preferably at least 90%, more preferably at least 100%, more preferably at least 110%.

The polymer composition may have a compression set of at most 150%, preferably of at most 140%, more preferably of at most 130%, more preferably of at most 120%, more preferably of at most 110%.

The polymer composition may have a compression set of between 50% and 150%, preferably between 60% and 140%, more preferably between 70% and 130%, more preferably between 80% and 130%, more preferably between 90% and 130%, more preferably between 90% and 120%.

The polymer composition may have a compression set of at most 50%, preferably of at most 40%, more preferably of at most 30%, more preferably of at most 25%.

The polymer composition may have a compression set of between 5% and 50%, preferably between 5% and 40%, more preferably between 10% and 40%, more preferably between 10% and 30%, more preferably between 15% and 25%.

The polymer composition may have an overall migration, determined according to DIN-EN 1186-14, of at most 5.5 mg cm⁻². Preferably, the overall migration is at most 3.5 mg cm⁻², more preferably at most 2.5 mg cm⁻², more preferably at most 2.0 mg cm⁻², more preferably at most 1.5 mg cm⁻², more preferably at most 1.0 mg cm⁻², more preferably at most 0.7 mg cm⁻², more preferably at most 0.5 mg cm⁻².

The polymer composition may have an oxygen transmission rate of less than 2700 cm³ m⁻² d⁻¹ bar⁻¹, preferably of less than 2500 cm³ m⁻² d⁻¹ bar⁻¹, more preferably of less than 2300 cm⁻³ m⁻² d⁻¹ bar⁻¹, more preferably of less than 2000 cm³ m⁻² d⁻¹ bar⁻¹, more preferably of less than 1700 cm³ m⁻² d⁻¹ bar⁻¹, more preferably of less than 1400 cm³ m⁻² d⁻¹ bar⁻¹, more preferably of less than 1100 cm³ m⁻² d⁻¹ bar⁻¹, more preferably of less than 800 cm³ m⁻² d⁻¹ bar⁻¹, more preferably of less than 700 cm³ m⁻² d⁻¹ bar⁻¹, more preferably of less than 600 cm³ m⁻² d⁻¹ bar⁻¹, more preferably of less than 500 cm³ m⁻² d⁻¹ bar⁻¹, more preferably of less than 400 cm³ m⁻² d⁻¹ bar⁻¹, more preferably of less than 300 cm³ m⁻² d⁻¹ bar⁻¹, more preferably of less than 200 cm⁻³ m⁻² d⁻¹ bar⁻¹, more preferably of less than 150 cm³ m⁻² d⁻¹ bar⁻¹.

The polymer composition may have a melting temperature Tm, determined by a second heating curve of a DSC measurement at a heating rate of 10° C./min, of at least 50° C. Preferably, the melting temperature Tm of the polymer composition is at least 60° C., more preferably at least 70° C.

The polymer composition may have a melting temperature Tm of at most 150° C. Preferably, the melting temperature Tm of the polymer composition is at most 120° C., more preferably at most 100° C.

The melting temperature Tm of the polymer composition may be between 50° C. and 150° C. Preferably, the melting temperature Tm of the polymer composition is between 60° C. and 140° C., more preferably between 70° C. and 130° C., more preferably between 70° C. and 120° C., more preferably between 80° C. and 115° C.

The melting temperature Tm of the polymer composition may be between 80° C. and 90° C. or between 105° C. and 115° C.

Particularly preferably, the polymer composition has no melting temperature (second heating curve of a DSC measurement at a heating rate of 10° C./min). In other words, a melting temperature of the polymer composition may not be measurable or not determinable at a second heating curve of a DSC measurement at a heating rate of 10° C./min.

The vessel closure may comprise a carrier and the sealing element. The carrier may comprise a planar section and a skirt section. In particular, the carrier may comprise metal, plastic or metal and plastic. In particular, the main constituent of the carrier is metal or plastic, in particular metal.

The vessel closure may be a screw closure. Preferably, the vessel closure is a lug closure. The vessel closure may also be a press-on twist-off vessel closure or a composite closure.

A vessel closure disclosed may close a vessel. The vessel comprises a vessel mouth and a closable opening at the end of the vessel mouth. This opening may be closed by one of the disclosed vessel closures.

The vessel may be a glass vessel, plastic vessel or metal vessel. In particular, the vessel is a glass vessel.

The vessel closure which closes the opening of the vessel may comprise a carrier and the sealing element. The carrier may have a lower side and the vessel mouth may have an upper end. The sealing element of the vessel closure is typically clamped between the vessel mouth and the carrier of the vessel closure, such that the sealing element contacts both the upper end of the vessel mouth and the lower side of the carrier. In particular, the height of the sealing element between the upper end of the vessel mouth and the lower side of the carrier is at most 1.0 mm. This height is preferably at most 0.8 mm and particularly preferably at most 0.7 mm. The height can be determined in the axial direction of the vessel.

Analogously thereto, the height of the sealing element between the upper end of the vessel mouth and the lower side of the carrier may be at least 0.2 mm. In particular, the height is at least 0.4 mm and particularly preferably at least 0.5 mm. The height of the sealing element can be measured in the axial direction of the vessel.

Particularly preferably, the height of the sealing element between the upper end of the vessel mouth and the lower side of the carrier is between 0.3 mm and 0.9 mm.

If, for example, the height of the sealing element before the vessel closure is applied to a vessel is 1.2 mm, an impression of the upper end of the vessel mouth in the sealing element (height between the upper end of the vessel mouth and the lower side of the carrier of at most 1.0 mm) without the sealing element being cut through (height of the sealing element between the upper end of the vessel mouth and the lower side of the carrier of at least 0.2 mm) ensures a high tightness of the vessel closed by the vessel closure.

A vacuum preferably prevails in the closed vessel. The absolute pressure in the closed vessel may be at most 200 hPa. In particular, the absolute pressure in the closed vessel is at most 100 hPa.

The vessel closed by the vessel closure may have a safety measure of at most 10 mm; in particular, the safety dimension is at most 8 mm. The safety measure is preferably at most 6 mm. Most preferably, the safety measure is at most 4 mm.

To determine the safety measure, a vessel closed by a lug closure is stored at room temperature (23° C.) for a period of 30 minutes. The relative position of the vessel closure with respect to the vessel is marked by applying a marking on the vessel closure skirt and the vessel wall such that the circumferential distance between the marking on the vessel closure skirt and the vessel wall is zero. The markings lie on a straight line which is parallel to the longitudinal axis of the vessel. Subsequently, the vessel closure is completely removed from the vessel by unscrewing. Subsequently, the vessel closure is placed onto the vessel and turned on until a slight resistance can be felt. The vessel closure is thus screwed on in a finger-tight manner. Subsequently, the circumferential distance between the marking on the vessel closure skirt and the marking on the vessel wall is measured. The measured distance corresponds to the safety measure expressed in mm.

As a result of the at least sectionally steep pitch of the threads of vessels and lug closures, the precision of the measurement of the safety measure is high since the point at which a slight resistance can be felt during the screwing on of the vessel closure (in a finger-tight manner) can be determined precisely. The precision of the measurement of the safety measure on closed vessels which have been closed under the same conditions by different persons is typically approximately ±1 mm.

A suitable safety measure ensures that the sealing element exerts an elastic force on at least the upper end of the vessel mouth when the vessel is closed by the vessel closure. This results in a high tightness of the interior of the closed vessel.

The opening of the vessel may have a diameter of at least 20 mm. In particular, the diameter of the opening of the vessel is at most 120 mm.

The vessel may be a glass vessel, plastic vessel or metal vessel.

Before the opening of the vessel is closed by the vessel closure, the vessel closure may be treated at a temperature of at least 90° C. Such a treatment may be carried out, for example, with steam.

A headspace may be formed in the vessel after the vessel has been filled with the foodstuff. After the filling, the headspace in the vessel is the section of the vessel contents in which no foodstuff is present. Steam may be supplied to the headspace before the vessel closure is applied to the vessel and the opening of the vessel is thus closed. In particular, the steam may be water steam.

The absolute pressure in the closed and filled vessel may be at most 200 hPa. In particular, the pressure in the closed and filled vessel may be at most 100 hPa.

To form an impression of the vessel mouth into the sealing element, the sealing element may be deformed at least 0.2 mm in the axial direction of the vessel during the closing of the opening of the vessel with the vessel closure and/or a thermal treatment of the closed and filled vessel. This deformation of the sealing element is preferably at least 0.4 mm. In particular, the deformation is at least 0.5 mm.

Analogously, the sealing element may be deformed by at most 1.0 mm to form an impression of the vessel mouth into the sealing element during the closing of the opening of the vessel with the vessel closure and/or a thermal treatment of the closed and filled vessel. In particular, the deformation is at most 0.8 mm. More preferably, the deformation is at most 0.7 mm. This in each case in the axial direction of the vessel.

Particularly preferably, the deformation of the sealing element is between 0.3 mm and 0.9 mm.

The foodstuff may be introduced into the vessel aseptically.

The foodstuff may also be introduced into the vessel with a temperature of at most 10° C.

The foodstuff may also be introduced into the vessel with a temperature between 10° C. and 70° C.

Likewise, the foodstuff may be introduced into the vessel with a temperature between 70° C. and 98° C.

Within the method, the closed and filled vessel may be thermally treated. In this case, the temperature of the thermal treatment is therefore above the temperature of the (solid and/or liquid) foodstuff during the filling of the vessel.

The thermal treatment may be carried out at a temperature of at least 60° C.

The thermal treatment may also be carried out at a temperature of at most 135° C. (between 60° C. and 135° C.). In particular, the thermal treatment is carried out at a temperature of up to 135° C. (between 60° C. and 135° C.) at an absolute ambient pressure of at most 4.0 bar, preferably at an absolute ambient pressure between 1.0 bar and 4.0 bar.

Preferably, the pressure in the closed vessel during a thermal treatment is lower than the pressure outside the closed vessel.

The embodiments of the disclosure are illustrated by way of examples, but not in a way in which restrictions from the figures are transferred or read into the claims. Like reference signs in the figures indicate like elements.

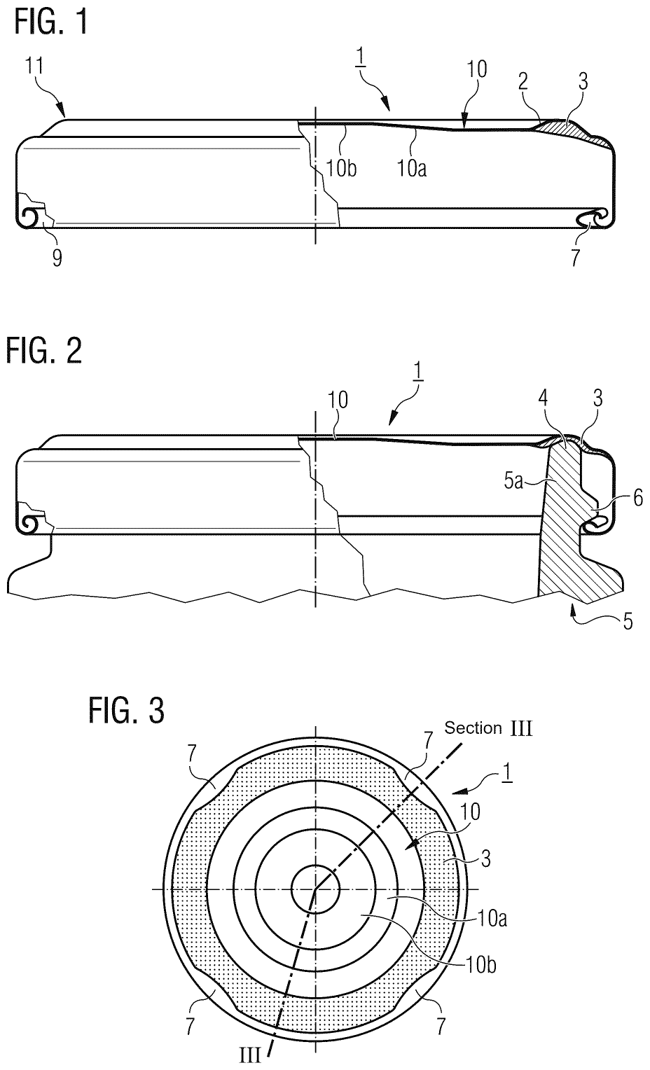

FIG. 1 shows a side view of a lug closure 1 with a ring-shaped sealing element 3, partially as a section;

FIG. 2 shows a side view of the lug closure 1 with the sealing element 3 on a vessel 5, partially as a section;

FIG. 3 shows the lug closure 1 with the sealing element 3 in a bottom view;

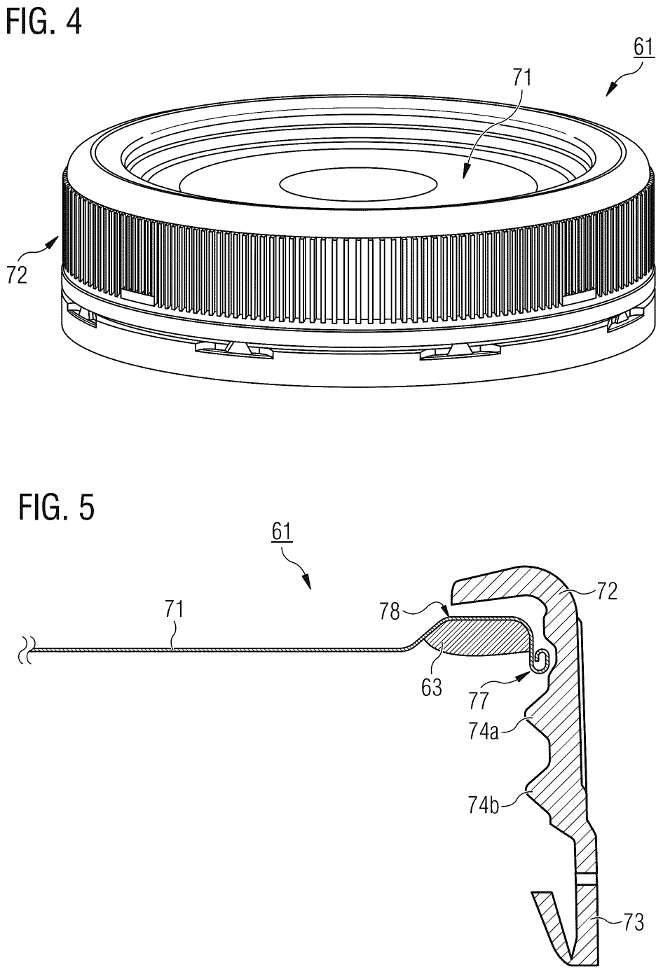

FIG. 4 shows an isometric view of a composite closure 61 (combi-twist);

FIG. 5 shows partially an axial section of the composite closure 61 (combi-twist) from FIG. 4;

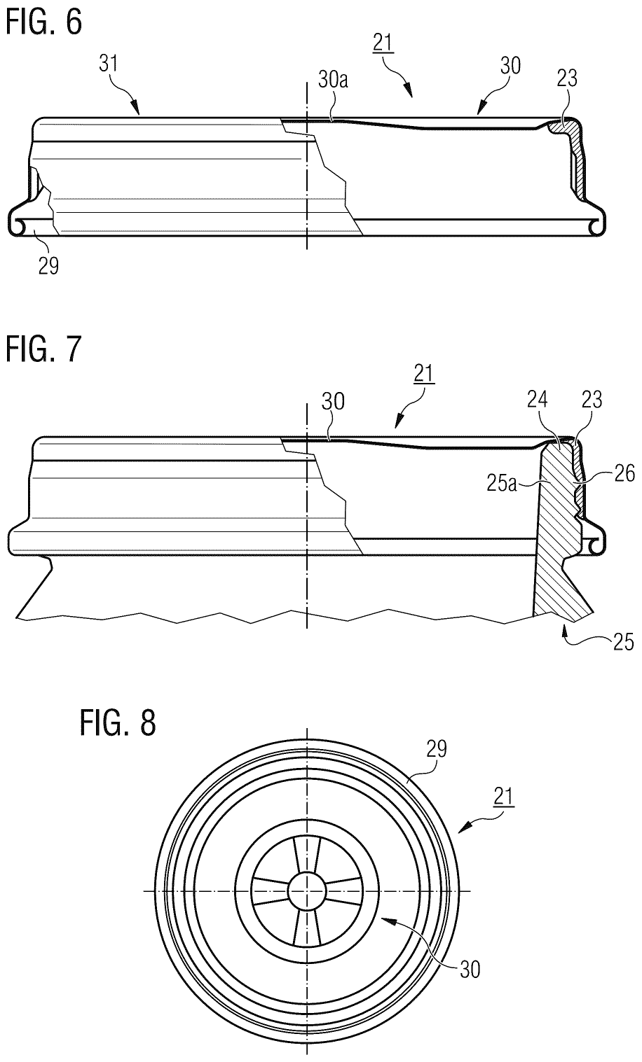

FIG. 6 shows a side view of a press-on twist-off closure 21 (PT closure) with a sealing element 23, partially as a section;

FIG. 7 shows a side view of the PT closure 21 with the sealing element 23 on a vessel 25, partially as a section;

FIG. 8 shows a top view of the PT closure 21;

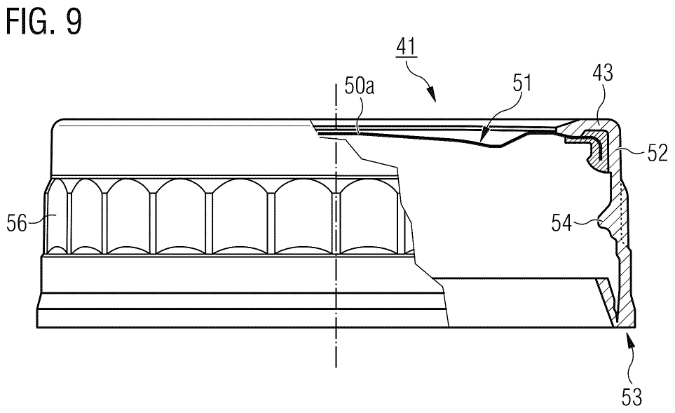

FIG. 9 shows a side view of a composite closure 41 (band-guard) with a sealing element 43, partially as a section;

FIG. 10 shows a side view of the composite closure 41 (band-guard) with the sealing element 43 on a vessel 45, partially as a section;

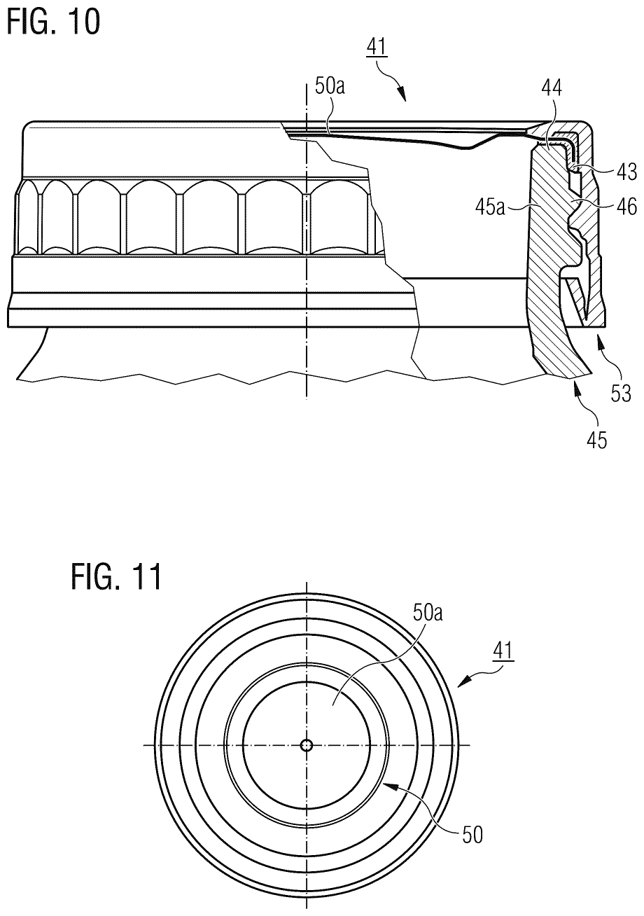

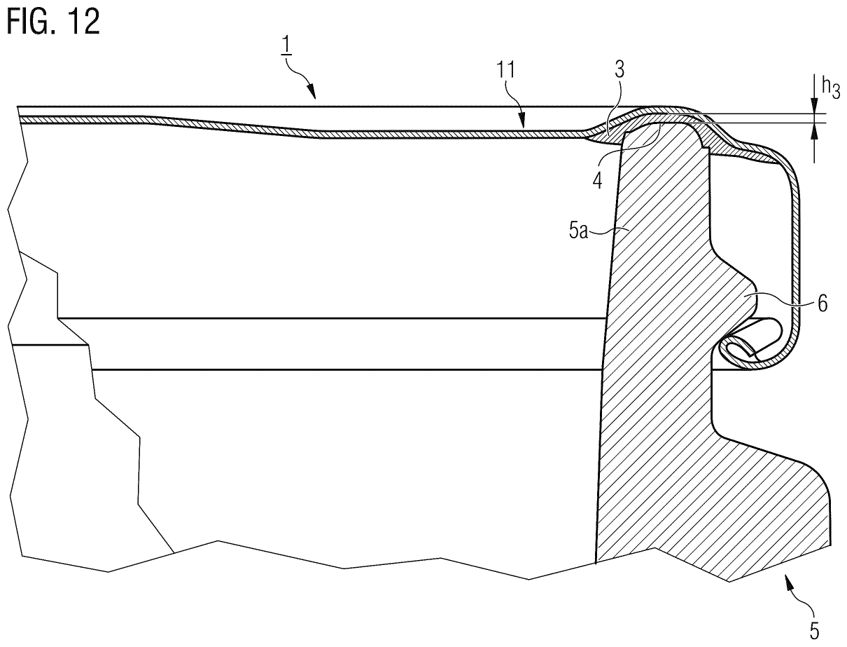

FIG. 11 shows a top view of the composite closure 41 (band-guard);

FIG. 12 shows an enlarged detail of the lug closure from FIG. 2.

FIGS. 1 and 3 show a lug closure 1. The lug closure 1 may comprise a metallic carrier 11 and may comprise a sealing element 3. In the illustration in FIG. 2, the lug closure 1 is applied to a vessel 5. A curl 9 may be formed at the lower end of the lug closure 1. A plurality of lugs 7 may be formed circumferentially distributed from the edge-side curl, in particular curl 9. Lugs 7 may be formed by an axial deformation of the curl 9 and may extend radially further to the center of the lug closure 1 than the curl 9. The lug closure 1 illustrated in FIGS. 1 to 3 comprises four lugs 7, which may be formed circumferentially uniformly distributed. The sections which are partially illustrated in FIGS. 1 and 2 correspond to the section III-III in FIG. 3.

In general, the vessel closure may have at least three lugs, preferably at least four lugs, more preferably at least six lugs. The vessel closure may have three to six lugs.

Close to the radially outer end section of the lug closure 1, a channel 2 may be formed in the upper section 10 of the carrier 11. The sealing element 3 may be arranged at least partially in the channel 2. In this embodiment, the sealing element 3 is ring-shaped; in other embodiments, the sealing element 3 may be disk-shaped, in particular if the diameter of the lug closure is small (e.g. at most 30 mm).

For adhesion between the metallic carrier 11 and the sealing element 3, an adhesive lacquer may be applied to that side of the metallic carrier 11 which is in contact with the sealing element 3.

In FIG. 2, the lug closure 1 is applied to a vessel 5. The vessel 5 may comprise a vessel mouth 5a as the upper section of the vessel 5. The vessel mouth may comprise a thread 6 and may comprise an upper end 4 of the vessel mouth 5a. The thread 6 may be formed circumferentially in the region of the vessel mouth 5a and may extend circumferentially upwards or downwards (depending on the viewing angle).

For applying the lug closure 1 to a vessel 5, lugs 7 may be brought into contact with sections of the thread 6 and the lug closure 1 may be rotated clockwise relative to the vessel 5. As a result of the configuration of the thread 6 and the interaction of the lugs 7 with the thread 6, the upper end 4 of the vessel mouth 5a can move in the direction of the sealing element 3 during the rotational movement of the lug closure 1 relative to the vessel 5. As a result of a further rotational movement of the lug closure 1, the upper end 4 of the vessel mouth 5a may press into the sealing element 3 and may deform the latter, such that a section of the upper end 4 of the vessel mouth 5a may be covered by the sealing element 3, as a result of which the vessel 5 may be closed in a sealed manner. A tight closing of the vessel 5 is necessary in particular in order to withstand an increased pressure during a thermal treatment of the closed vessel 5 at temperatures above 70° C., 90° C. or even above 120° C.

The lug closure 1, as illustrated in FIGS. 1 to 3, may comprise a safety element, preferably a (planar) safety button 10b, which is formed in the upper section 10 of the carrier 11. The button 10b is optional. On account of the pitch 10a in the upper section 10 of the carrier 11, the button 10b can fold in the direction of the center of the vessel if a sufficiently large negative pressure is present in the vessel. Such a vacuum may be generated by introducing water steam into the vessel before the vessel is closed by the closure.

If a consumer opens the vessel by removing the vessel closure, the pressure in the vessel rises to ambient pressure and the button 10b folds away from the center of the vessel. The folding over of the button 10b is accompanied by a characteristic noise, by means of which a consumer can identify that a vacuum has prevailed in the vessel before the vessel is opened.

FIGS. 4 and 5 show a composite closure 61 (combi-twist) which, analogously to the described lug closure 1, can be applied to a vessel by a rotational movement and can be removed from the vessel by a rotational movement.

The composite closure 61 may comprise a carrier with an upper metallic section 71 and may comprise a plastic section 72 which is formed in an L-shape. Close to the radial end of the metallic section 71 of the carrier, a channel 78 may be formed and a curl 77 may be formed at the radial end of the metallic section 71. A sealing element may be arranged at least partially in the channel 78.

A plurality of threaded elements 74a, 74b formed on the inner side of the plastic section 72 may contact or engage with a mating thread in the region of the mouth of a vessel (not illustrated) to which the composite closure 61 is to be applied. The plastic section 72 of the composite closure 61 may comprise a tamper-evident means 73 which is configured similarly to the tamper-evident means as in FIGS. 9 to 11 and will be described in more detail with regard to FIGS. 9 to 11.

If the composite closure 61 is screwed onto a vessel by a rotational movement, an analogous interaction of the vessel mouth of the vessel with the sealing element of the composite closure 61 results as described with reference to the lug closure 1.

In FIGS. 6 to 8, a press-on twist-off closure 21 (PT closure) is illustrated. The PT closure 21 may comprise a metallic carrier 31 with a curl 29 at the lower end of the carrier 31. The PT closure 21 may comprise a button 30a in the upper section 30 of the carrier 31. The button 30a is optional.

A sealing element 23 may be formed both in the region of the upper section 30 of the carrier 31 and to a considerable extent (at least 10%, at least 20%, at least 30%, at least 40%, at least 50% or at least 60% of the total volume of the sealing element), on the skirt of the carrier which extends downwards starting from the upper section 30 of the carrier 31. In contrast to the lug closure 1 and the composite closure 61, the PT closure 21 may be pressed onto the vessel mouth 25a during application to a vessel 25. During pressing onto the vessel mouth 25a, the sealing element 23 may be sufficiently soft to elastically enclose threaded elements 26 of the vessel mouth 25a. For this purpose, the sealing element 23 is typically treated with water steam before the PT closure 21 is applied to a vessel 5, in order to cause the necessary softness of the sealing element 23. After cooling of the sealing element 23, a mating thread in the form of a negative of the threaded elements 26 of the vessel mouth may be formed in the sealing element 23.

An upper end 24 of the vessel mouth 25a may contact the sealing element 23.

In order to open the vessel 25, the PT closure 21 can be removed from the vessel 25 by a rotational movement.

FIGS. 9 to 11 show a composite closure 41 (band-guard) which is functional analogously to the described PT closure 21.

The composite closure 41 may comprise a carrier with a metallic section 51 and a plastic section 52. The composite closure 41 may comprise a tamper-evident means 53. The composite closure 41 may comprise an optional button 50a. The tamper-evident means 53 may be configured such that it can be removed from the remainder of the composite closure 41 when the composite closure 41 is removed from a vessel 45, and can serve for the checkability of a consumer as to whether the composite closure 41 has already been removed from the vessel 45. The button 50a may be configured and functional analogously to the button 10b of the lug closure 1.

The plastic section of the composite closure 41 may comprise a plurality of axially running indentations 56 in order to increase the stability of the closure.

A sealing element 43 may be arranged in the composite closure 41 such that it contacts both the metallic section 51 and the plastic section 52. In order to close a vessel 45, the composite closure 41 may be pressed onto the vessel mouth 45a of the vessel 45, such that at least the upper end 44 of the vessel mouth 45a may contact the sealing element 43.

The plastic section 52 of the carrier may comprise a plurality of offset projections 54 which may interact with threaded elements 46 of the vessel mouth 45a. In order to open a vessel 45 which is closed by the composite closure 41, the composite closure 41 may be rotated relative to the vessel 45.

The distance h₃ of a sealing element 3 between an upper end 4 of a vessel mouth 5a of a vessel 5 and the lower side of a carrier 11 of the closure 1 is illustrated in FIG. 12 with regard to a lug closure 1 and is described here. Analogously, the distance (height) h₃ can be determined for other closure types.

The sealing element 3 clamped between the vessel mouth 5 and the carrier 11 of the vessel closure 1 may have a height h₃ which is given when a vessel 5 is closed by the closure 1. If the height h₃ is too low, an incision of the sealing element 3 may threaten or take place, as a result of which the tightness of the closed vessel 5 may be impaired. If the height h₃ is too large, the tightness of the closed vessel may be impaired since the contact area between the upper end 4 of the vessel mouth 5a and the sealing element 3 is not sufficiently large. To achieve a suitable impression of the upper end 4 of the vessel mouth 5a in the sealing element, the composition of the sealing element 3 is decisive.

### First Examples

Examples of polymer compositions for sealing elements in a vessel closure are illustrated in the following tables.

TABLE 1

| | Exam- | Exam- | Exam- | Exam- | Exam- |
|---|---|---|---|---|---|
| | ple 1 | ple 2 | ple 3 | ple 4 | ple 5 |
| Component, wt.-% | | | | | |
| C4C2 | 71.9 | | 71.9 | | 71.9 |
| C2C8 | | 71.9 | | 71.9 | |
| COC I | 24.0 | 24.0 | | | |
| COC II | | | 24.0 | 24.0 | |
| COC III | | | | | 24.0 |
| COC IV | | | | | |
| PAO | | | | | |
| Additives | 4.1 | 4.1 | 4.1 | 4.1 | 4.1 |
| Properties | | | | | |
| Coefficient | 0.47 | | 0.26 | | 0.33 |
| of friction, | | | | | |
| dimensionless | | | | | |
| Overall migration, | 0.8 | | 0.4 | | 0.5 |
| mg cm⁻² | | | | | |
| OTR, cm³ m⁻² | 562 | | 117 | | 219 |
| d⁻¹ bar⁻¹ | | | | | |
| DVR 70° C., % | 108 | | 115 | | 115 |
| Shore A 23° C., | 73 | | 90 | | 85 |
| dimensionless | | | | | |
| DSC Tm max, ° C. | 85 | | no | | no |

TABLE 2

| | Exam- | Exam- | Exam- | Exam- | Exam- |
|---|---|---|---|---|---|
| | ple 6 | ple 7 | ple 8 | ple 9 | ple 10 |
| Component, wt.-% | | | | | |
| C4C2 | | 71.9 | | | |
| C2C8 | 71.9 | | 71.9 | | |
| COC I | | | | 85.9 | 75.9 |
| COC II | | | | | |
| COC III | 24.0 | | | | |
| COC IV | | 24.0 | 24.0 | | |
| PAO | | | | 10.0 | 20.0 |
| Additives | 4.1 | 4.1 | 4.1 | 4.1 | 4.1 |
| Properties | | | | | |
| Coefficient | | 0.25 | | 0.21 | 0.15 |
| of friction, | | | | | |
| dimensionless | | | | | |
| Overall migration, | | 0.4 | | 1.1 | 1.8 |
| mg cm⁻² | | | | | |
| OTR, cm³ m⁻² | | 197 | | 251 | 363 |
| d⁻¹ bar⁻¹ | | | | | |
| DVR 70° C., % | | 112 | | 94 | 21 |
| Shore A 23° C., | | 86 | | 84 | 71 |
| dimensionless | | | | | |
| DSC Tm max, ° C. | | no | | 85 | 110 |

TABLE 3

| Component | Exam- | Exam- | Exam- | Exam- | Exam- | Exam- |
|---|---|---|---|---|---|---|
| wt.-% | ple 11 | ple 12 | ple 13 | ple 14 | ple 15 | ple 16 |
| C4C2 | | | | | 71.9 | 71.9 |
| COC I | 95.9 | 71.9 | 71.9 | 71.9 | | |
| COC IV | | 24.0 | | | | |
| COC V | | | 24.0 | | 24.0 | |
| COC VI | | | | 24.0 | | 24.0 |
| Additives | 4.1 | 4.1 | 4.1 | 4.1 | 4.1 | 4.1 |

| | |
|---|---|
| C4C2 | is a 1-butene-ethene copolymer having a 1-butene content of more than 80%. The |
| | density is 0.870 g cm⁻³. The Shore A hardness is 60. |
| C2C8 | is an ethene-1-octene block copolymer having a compression set at 70° C. of 70% and |
| | a Shore A hardness (23° C.) of 60. For example, olefinic block copolymers of the |
| | Infuse ™ series from Dow may be used. |
| COC I | is a cyclic olefin copolymer of the monomers ethene and norbornene |
| | (bicyclo[2.2.1]hept-2-ene). The Shore A hardness is about 89. The glass transition |
| | temperature Tg is about 6° C. (determined by ISO 11357-1,-2,-3, 10° C./min). The |
| | density is about 0.940 g cm⁻³. |
| COC II | is a cyclic olefin copolymer of the monomers ethene and norbornene |
| | (bicyclo[2.2.1]hept-2-ene). The Shore D hardness is about 77. The glass transition |
| | temperature Tg is about 65° C. (determined by ISO 11357-1,-2,-3, 10° C./min). The |
| | density is about 1.010 g cm⁻³. |
| COC III | is a cyclic olefin copolymer of the monomers ethene and norbornene |
| | (bicyclo[2.2.1]hept-2-ene). The Shore D hardness is about 77. The glass transition |
| | temperature Tg is about 78° C. (determined by ISO 11357-1,-2,-3, 10° C./min). The |
| | density is about 1.010 g cm⁻³. |
| COC IV | is a cyclic olefin copolymer of the monomers ethene and norbornene |
| | (bicyclo[2.2.1]hept-2-ene). The Shore D hardness is about 79. The glass transition |
| | temperature Tg is about 138° C. (determined by ISO 11357-1,-2,-3, 10° C./min). The |
| | density is about 1.020 g cm⁻³. |
| COC V | is a cyclic olefin copolymer of the monomers ethene and norbornene |
| | (bicyclo[2.2.1]hept-2-ene). The glass transition temperature Tg is about 158° C. |
| | (determined by ISO 11357-1,-2,-3, 10° C./min). The density is about 1.020 g cm⁻³. |
| COC VI | is a cyclic olefin copolymer of the monomers ethene and norbornene |
| | (bicyclo[2.2.1]hept-2-ene). The glass transition temperature Tg is about 178° C. |
| | (determined by ISO 11357-1,-2,-3, 10° C./min). The density is about 1.020 g cm⁻³. |
| PAO | is a (metallocene)polyalphaolefin (alpha-decene homopolymer) having a kinematic |
| | viscosity at 100° C. of about 65 cSt. |

The cyclic olefin copolymers (COC I to COC VI) are obtainable from “TOPAS Advanced Polymers”.

The coefficient of friction is the static coefficient of friction determined according to DIN EN ISO 8295.

In general, the polymer composition may have a static coefficient of friction of at most 1.0, preferably at most 0.8, more preferably at most 0.7.

The overall migration is determined according to DIN-EN 1186-14.

The OTR (oxygen transmission rate) is determined according to DIN 53380.

The DVR (compression set) is determined according to ASTM D 395, 70° C., 22 h.

The Shore A hardness is determined at a temperature of 23° C. and a holding time of 15 s (DIN ISO 7619). The Shore D hardness is determined analogously (DIN ISO 7619, 23° C., 15 s).

The melting temperature Tm was determined by a second heating curve of a DSC measurement at a heating rate of 10° C. min⁻¹. A value of “no” means that no melting temperature could be determined, i.e. a melting temperature is not present in the composition.

In general, no specific component is necessarily present in the polymer composition. In particular, an increased occurrence of a component in the examples is not an indication that this component must necessarily be present in the polymer composition. Rather, components from the compositions of the examples can be omitted or replaced by other component(s). Likewise, components can be added.

The weight fractions of the components in the compositions and the properties of the compositions of the examples are exemplary. The disclosure is not restricted to the values of the weight fractions of the components and/or the values of the properties of the examples.

Standards mentioned in this application for measuring (physical) properties may relate to the version valid in each case on the priority date or filing date of the application.

### Further Examples

Examples are illustrated below as embodiments, wherein the preceding number represents the number of the example.
1. Vessel closure (1, 21, 41, 61) with a sealing element (3, 23, 43, 63), wherein the sealing element (3, 23, 43, 63) comprises a polymer composition, wherein the polymer composition comprises:
   (a) at least 1 wt.-% of a cyclic olefin polymer, and/or
   (b) wherein the oxygen transmission rate of the polymer composition, determined according to DIN 53380, is at most 3000 cm³ m⁻² d⁻¹ bar⁻¹.
2. Vessel closure according to Example 1, wherein the cyclic olefin polymer has a Shore A hardness, determined according to DIN ISO 7619 at a temperature of 23° C. and a holding time of 15 s, of at least 40, preferably at least 50, more preferably at least 60.
3. Vessel closure according to either of Examples 1 and 2, wherein the cyclic olefin polymer has a Shore A hardness, determined according to DIN ISO 7619 at a temperature of 23° C. and a holding time of 15 s, of at least 70.
4. Vessel closure according to any of the preceding examples, wherein the cyclic olefin polymer has a Shore D hardness, determined according to DIN ISO 7619 at a temperature of 23° C. and a holding time of 15 s, of at least 20, preferably at least 30, more preferably at least 40, more preferably at least 50, more preferably at least 60, most preferably at least 70.
5. Vessel closure according to any of the preceding examples, wherein the cyclic olefin polymer has a density, determined according to ISO 1183, of at least 0.850 g cm⁻³, preferably at least 0.870 g cm⁻³, more preferably at least 0.890 g cm⁻³, more preferably at least 0.910 g cm⁻³, more preferably at least 0.930 g cm⁻³, more preferably at least 0.950 g m⁻³, more preferably at least 0.970 g m³, more preferably at least 0.990 g cm⁻³, more preferably at least 1.010 g cm⁻³, most preferably between 0.920 g cm⁻³ and 1.050 g cm⁻³.
6. Vessel closure according to any of the preceding examples, wherein the cyclic olefin polymer has a glass transition temperature, determined according to ISO 11357-1, -2, -3, 10° C./min, of at least −20° C., preferably at least 0° C., more preferably at least 3° C., more preferably at least 40° C., more preferably at least 60° C., more preferably at least 70° C., more preferably at least 90° C., more preferably at least 110° C., more preferably at least 125° C., more preferably at least 130° C., more preferably at least 150° C., more preferably at least 170° C., most preferably between 0° C. and 190° C.
7. Vessel closure according to any of the preceding examples, wherein a (co)monomer of the cyclic olefin polymer is a monocyclic or polycyclic olefin, preferably the (co)monomer is a monocyclic or polycyclic C3 to C20 olefin, more preferably a monocyclic or polycyclic C5 to C20 olefin, more preferably a monocyclic or polycyclic C7 to C17 olefin, more preferably a monocyclic or polycyclic C7 to C12 olefin, more preferably a monocyclic or polycyclic C7 olefin, most preferably norbornene.
8. Vessel closure according to any of the preceding examples, wherein the cyclic olefin polymer is produced by ring-retaining or by ring-opening polymerization.
9. Vessel closure according to any of the preceding examples, wherein the cyclic olefin polymer is a cyclic olefin copolymer.
10. Vessel closure according to Example 9, wherein a (co)monomer of the cyclic olefin copolymer is a C2- to C10-(alpha)olefin, preferably a C2- to C8-(alpha)olefin, more preferably a C2- to C6-(alpha)olefin, most preferably ethene.
11. Vessel closure according to Example 9 or 10, wherein a monocyclic or polycyclic olefin as a comonomer of the cyclic olefin copolymer has a comonomer fraction of at least 10 mol-%, preferably of at least 20 mol-%, more preferably of at least 40 mol-%, more preferably of at least 60 mol-%, more preferably of at least 65 mol-%.
12. Vessel closure according to any of Examples 9 to 11, wherein ethene as a comonomer of the cyclic olefin copolymer has a comonomer fraction of at most 90 mol-%, preferably of at most 80 mol-%, more preferably of at most 60 mol-%, more preferably of at most 40 mol-%, more preferably of at most 35 mol-%.
13. Vessel closure according to any of the preceding examples, wherein the cyclic olefin polymer is an ethene-norbornene copolymer.
14. Vessel closure according to any of the preceding examples, wherein the cyclic olefin polymer is present in the polymer composition in an amount of at most 95 wt.-%, preferably at most 85 wt.-%, more preferably at most 50 wt.-%, more preferably at most 40 wt.-%, more preferably at most 30 wt.-%.
15. Vessel closure according to any of the preceding examples, wherein the polymer composition comprises up to 95 wt.-% of a further polymer, in particular wherein the polymer composition comprises between 1 wt.-% and 95 wt.-% of a further polymer.
16. Vessel closure according to Example 15, wherein the further polymer is a (random or block) copolymer, preferably wherein ethene and at least one C3 to C16 (alpha-)olefin are comonomers of the (random or block) copolymer, more preferably wherein ethene and at least one C3 to C8 (alpha-)olefin are comonomers of the (random or block) copolymer.
17. Vessel closure according to Example 16, wherein ethene as a comonomer of the (random or block) copolymer has a comonomer fraction of more than 50 mol-%, preferably of more than 60 mol-%, more preferably of more than 70 mol-%.
18. Vessel closure according to Example 16 or 17, wherein ethene and a C3 to C16 (alpha-)olefin, preferably ethene and a C3 to C8 (alpha-)olefin, are comonomers of the (random or block) copolymer, most preferably the further polymer is an ethene-octene block copolymer.
19. Vessel closure according to Example 16, wherein ethene as a comonomer of the (random or block) copolymer has a comonomer fraction of less than 50 mol-%, preferably of less than 40 mol-%, more preferably of less than 30 mol-%, more preferably of less than 20 mol-%.
20. Vessel closure according to Example 19, wherein a C3 to C16 (alpha-)olefin and ethene, preferably a C3 to C8 (alpha-)olefin and ethene, are comonomers of the (random or block) copolymer, most preferably the further polymer is a (random) butene-ethene copolymer.
21. Vessel closure according to Example 16, wherein ethene as a comonomer of the (random or block) copolymer has a comonomer fraction of more than 30 mol-%, preferably of more than 40 mol-%, more preferably of more than 50 mol-%, more preferably of more than 55 mol-%.
22. Vessel closure according to any of the preceding examples, wherein the polymer composition comprises a further cyclic olefin polymer.
23. Vessel closure according to Example 22, wherein the further cyclic olefin polymer is present in the polymer composition in an amount of at most 80 wt.-%, preferably at most 70 wt.-%, more preferably at most 60 wt.-%, more preferably at most 50 wt.-%, more preferably at most 40 wt.-%, more preferably at most 30 wt.-%.
24. Vessel closure according to any of the preceding examples, wherein the polymer composition contains less than 10 wt.-%, preferably less than 5 wt.-%, more preferably less than 2 wt.-% polyvinyl chloride, most preferably the polymer composition is free of polyvinyl chloride.
25. Vessel closure according to any of the preceding examples, wherein the polymer composition contains between 1 wt.-% and 60 wt.-%, preferably between 1 wt.-% and 45 wt.-%, more preferably between 1 wt.-% and 30 wt.-% of a component that is liquid at 20° C. and 1 bar.
26. Vessel closure according to Example 25, wherein the liquid component contains or is a polyalphaolefin having a kinematic viscosity, determined according to ASTM D445/ISO 3104, of at least 4 cSt at a temperature of 100° C. and/or having a dropping point, determined according to ASTM 5950, of at most −10° C.
27. Vessel closure according to Example 26, wherein the polyalphaolefin has a kinematic viscosity at a temperature of 100° C., determined according to ASTM D445/ISO 3104, between 4 cSt and 1500 cSt, preferably between 50 cSt and 1000 cSt, more preferably between 120 cSt and 1000 cSt, even more preferably between 250 cSt and 1000 cSt.
28. Vessel closure according to Example 26 or 27, wherein the polyalphaolefin has a dropping point, determined according to ASTM 5950, of at most −20° C., preferably of at most −30° C.
29. Vessel closure according to any one of Examples 26 to 28, wherein the polyalphaolefin has a density, determined according to ASTM D4052, of up to 0.860 g cm⁻³, in particular between 0.825 g cm⁻³ and 0.855 g cm⁻³.
30. Vessel closure according to any one of Examples 26 to 29, wherein the polyalphaolefin has an average molecular weight Mw, determined according to DIN 55672-1, of at least 440 Da, preferably between 440 Da and 12000 Da, particularly preferably between 1000 Da and 10000 Da, even more preferably between 3000 Da and 10000 Da.
31. Vessel closure according to any one of Examples 26 to 30, wherein the polyalphaolefin is a metallocene polyalphaolefin, in particular the polyalphaolefin has been produced using a metallocene catalyst.
32. Vessel closure according to any one of Examples 26 to 31, wherein the polyalphaolefin is a homopolymer or a copolymer, in particular the polyalphaolefin comprises a C3 to C22 alpha-olefin as (co)monomer.
33. Vessel closure according to any one of Examples 26 to 32, wherein the polyalphaolefin comprises a C6 to C14 alpha-olefin, preferably a C8 to C10 alpha-olefin, as (co)monomer.
34. Vessel closure according to any one of Examples 1 to 14 and 24 to 25, wherein the polymer composition contains at most one polymeric component, in particular wherein the cyclic olefin polymer is the one polymeric component.
35. Vessel closure according to any one of Examples 1 to 24 and 34, wherein the polymer composition contains less than 10 wt.-%, preferably less than 5 wt.-%, more preferably less than 2 wt.-% of a component that is liquid at 20° C. and 1 bar, most preferably the polymer composition is free of a component that is liquid at 20° C. and 1 bar.
36. Vessel closure according to any of the preceding examples, wherein the polymer composition comprises up to 15 wt.-%, preferably up to 8 wt.-%, more preferably up to 6 wt.-%, most preferably up to 5 wt.-%, additives.
37. Vessel closure according to the preceding example, wherein the additives are selected from the group consisting of: pigments, nucleating agents, brighteners, stabilizers, surfactants, lubricants, antioxidants and combinations thereof.
38. Vessel closure according to any of the preceding examples, wherein the polymer composition has a Shore A hardness, determined according to DIN ISO 7619 at a temperature of 23° C. and a holding time of 15 s, of at least 40, preferably at least 50, more preferably at least 60, more preferably at least 70, more preferably at least 80.
39. Vessel closure according to any of the preceding examples, wherein the polymer composition has a compression set, determined according to ASTM D 395, 70° C., 22 h, of at least 50%, preferably of at least 60%, more preferably of at least 70%, more preferably of at least 80%, more preferably of at least 90%,
40. Vessel closure according to any of the preceding examples, wherein the polymer composition has an overall migration, determined according to DIN-EN 1186-14, of at most 5.5 mg cm⁻², preferably of at most 3.5 mg cm⁻², more preferably of at most 2.5 mg cm⁻², more preferably of at most 1.5 mg cm⁻², more preferably of at most 1.0 mg cm⁻², more preferably of at most 0.7 mg cm⁻².
41. Vessel closure according to any of the preceding examples, wherein the polymer composition has an oxygen transmission rate of less than 1700 cm³ m⁻² d⁻¹ bar⁻¹, preferably of less than 1400 cm³ m⁻² d⁻¹ bar 1, more preferably of less than 1100 cm⁻³ m⁻² d⁻¹ bar⁻¹, more preferably of less than 800 cm³ m⁻² d⁻¹ bar⁻¹, more preferably of less than 700 cm³ m⁻² d⁻¹ bar⁻¹, more preferably of less than 600 cm³ m⁻² d⁻¹ bar-, more preferably of less than 500 cm³ m⁻² d⁻¹ bar⁻¹, more preferably of less than 400 cm⁻³ m⁻² d⁻¹ bar⁻¹, more preferably of less than 300 cm³ m⁻² d⁻¹ bar⁻¹.
42. Vessel closure according to any of the preceding examples, wherein the polymer composition, determined by a second heating curve of a DSC measurement at a heating rate of 10° C./min, has a melting temperature Tm of at least 50° C., preferably at least 60° C., more preferably at least 70° C.
43. Vessel closure according to any of the preceding examples, wherein the polymer composition, determined by a second heating curve of a DSC measurement at a heating rate of 10° C./min, has a melting temperature Tm of at most 150° C., preferably at most 120° C., more preferably at most 100° C.
44. Vessel closure according to any of the preceding examples 1 to 41, wherein the polymer composition, determined by a second heating curve of a DSC measurement at a heating rate of 10° C./min, has no melting temperature Tm.
45. Vessel closure according to any of the preceding examples, wherein the vessel closure comprises a carrier (11, 31, 51, 71) and the sealing element (3, 23, 43, 63), wherein the carrier (11, 31, 51, 71) comprises metal and/or plastic, in particular comprises metal or plastic as main constituent.
46. Vessel closure according to any of the preceding examples, wherein the vessel closure (1, 21, 41, 61) is a screw closure, in particular a lug closure (1), a press-on twist-off closure (21) or a composite closure (41, 61).
47. Vessel closure according to any of the preceding examples, wherein a monocyclic or polycyclic olefin has a fraction of at least 2 mol-%, preferably at least 5 mol-%, more preferably at least 10 mol-%, more preferably at least 20 mol-%, more preferably at least 40 mol-%, more preferably at least 60 mol-%, more preferably at least 65 mol-%, in the cyclic olefin polymer.
48. Vessel closure according to any of the preceding examples, wherein exactly one monomer or at most one monomer has been used for the production of the cyclic olefin polymer.
49. Vessel closure according to any of the preceding examples, wherein the cyclic olefin polymer comprises a monocyclic C5 unit.
50. Vessel (5, 25, 45) having a vessel mouth (5a, 25a, 45a) and a closable opening at the end of the vessel mouth, wherein the opening is closed by a vessel closure (1, 21, 41, 61) according to any of the preceding claims.
51. Vessel according to Example 50, wherein the vessel closure comprises a carrier (11, 31, 51, 71) and the sealing element (3, 23, 43, 63), and wherein the sealing element between an upper end (4, 24, 44) of the vessel mouth and a lower side of the carrier (11, 31, 51, 71) has a height (h₃) of at most 1.0 mm, preferably at most 0.8 mm, particularly preferably at most 0.7 mm, in the axial direction of the vessel.
52. Vessel according to Example 50 or 51, wherein the vessel closure comprises a carrier (11, 31, 51, 71) and the sealing element (3, 23, 43, 63), and wherein the sealing element between an upper end (4, 24, 44) of the vessel mouth and a lower side of the carrier (11, 31, 51, 71) has a height (h₃) of at least 0.2 mm, preferably at least 0.4 mm, particularly preferably at least 0.5 mm, in the axial direction of the vessel.
53. Vessel according to any of Examples 50 to 52, wherein the vessel has a safety measure of at most 10 mm, preferably at most 8 mm, particularly preferably at most 6 mm, most preferably at most 4 mm.
54. Method for producing a closed and filled vessel, comprising the steps:
   (a) providing a vessel (1, 21, 41, 61) having a vessel mouth (5a, 25a, 45a) and a closable opening at the end of the vessel mouth;
   (b) filling the vessel with a foodstuff through the opening of the vessel;
   (c) closing the opening of the vessel by a vessel closure according to any of the preceding examples.
55. Method according to Example 54, wherein the vessel closure is treated at a temperature of at least 90° C. before the opening of the vessel is closed by the vessel closure.
56. Method according to either of Examples 54 and 55, wherein the absolute pressure in the closed and filled vessel is at most 200 hPa, preferably at most 100 hPa.
57. Method according to one of Examples 54 to 56, wherein the sealing element of the vessel closure is deformed by at least 0.2 mm, preferably at least 0.4 mm, particularly preferably at least 0.5 mm, in the axial direction of the vessel during the closing of the opening of the vessel with the vessel closure and/or a thermal treatment of the closed and filled vessel to form an impression of the vessel mouth into the sealing element.
58. Method according to one of Examples 4 to 57, wherein the sealing element of the vessel closure is deformed by at most 1.0 mm, preferably at most 0.8 mm, particularly preferably at most 0.7 mm, in the axial direction of the vessel during the closing of the opening of the vessel with the vessel closure and/or a thermal treatment of the closed and filled vessel to form an impression of the vessel mouth into the sealing element.

What is claimed is:

1. A vessel closure comprising a sealing element, wherein the sealing element comprises a polymer composition, wherein the polymer composition comprises:
(a) at least 1 wt.-% of a cyclic olefin copolymer,
(b) wherein the oxygen transmission rate of the polymer composition, determined according to DIN 53380, is at most 3000 cm³ m⁻² d⁻¹ bar⁻¹, and
(c) wherein the cyclic olefin copolymer is a bipolymer.

2. The vessel closure according to claim 1, wherein the cyclic olefin copolymer has a glass transition temperature, determined according to ISO 11357-1, -2, -3, 10° C./min, of at least −20° C.

3. The vessel closure according to claim 1, wherein a comonomer of the cyclic olefin copolymer is a monocyclic or polycyclic olefin.

4. The vessel closure according to claim 1, wherein a comonomer of the cyclic olefin copolymer is a C2- to C10-(alpha)olefin.

5. The vessel closure according to claim 1, wherein the polymer composition comprises up to 95 wt.-% of a further polymer.

6. The vessel closure according to claim 5, wherein the further polymer is a (random or block) copolymer.

7. The vessel closure according to claim 6, wherein ethene and a C3 to C16 (alpha-)olefin are comonomers of the (random or block) copolymer.

8. The vessel closure according to claim 1, wherein the polymer composition comprises between 1 wt.-% and 60 wt.-% of a component that is liquid at 20° C. and 1 bar.

9. The vessel closure according to claim 8, wherein the liquid component comprises a polyalphaolefin having a kinematic viscosity, determined according to ASTM D445/ISO 3104, of at least 4 cSt at a temperature of 100° C. and/or having a dropping point, determined according to ASTM 5950, of at most −10° C.

10. The vessel closure according to claim 1, wherein the polymer composition
(a) has a Shore A hardness, determined according to DIN ISO 7619 at a temperature of 23° C. and a holding time of 15 s, of at least 40; or
(b) has a compression set, determined according to ASTM D 395, 70° C. 22 h of at least 50%; or
(c) both (a) and (b).

11. The vessel closure according to claim 1, wherein the polymer composition comprises a further cyclic olefin polymer.

12. The vessel closure according to claim 1, wherein the polymer composition comprises at most one polymeric component.

13. The vessel closure according to claim 3, wherein the monocyclic or polycyclic olefin has a fraction of at least 10 mol-% in the cyclic olefin polymer.

14. A vessel comprising a vessel mouth and a closable opening at the end of the vessel mouth, wherein the closable opening is closed by a vessel closure comprising a sealing element, wherein the sealing element comprises a polymer composition, wherein the polymer composition comprises:
(a) at least 1 wt.-% of a cyclic olefin copolymer, and
(b) wherein the oxygen transmission rate of the polymer composition, determined according to DIN 53380, is at most 3000 cm³ m⁻² d⁻¹ bar⁻¹, and
(c) wherein the cyclic olefin copolymer is a bipolymer.

15. A method for producing a closed and filled vessel, comprising:
(a) providing a vessel having a vessel mouth and a closable opening at the end of the vessel mouth;
(b) filling the vessel with a foodstuff through the opening of the vessel; and
(c) closing the opening of the vessel by a vessel closure comprising a sealing element, wherein the sealing element comprises a polymer composition, wherein the polymer composition comprises:
(1) at least 1 wt.-% of a cyclic olefin copolymer, and
(2) wherein the oxygen transmission rate of the polymer composition, determined according to DIN 53380, is at most 3000 cm³ m⁻² d⁻¹ bar⁻¹, and
(3) wherein the cyclic olefin copolymer is a bipolymer.

16. A vessel closure comprising a sealing element, wherein the sealing element comprises a polymer composition, wherein the polymer composition comprises:
(a) at least 1 wt.-% of a cyclic olefin copolymer, and
(b) wherein the oxygen transmission rate of the polymer composition, determined according to DIN 53380, is at most 3000 cm³ m⁻² d⁻¹ bar⁻¹,
(c) wherein a monocyclic or polycyclic olefin has a fraction of at least 10 mol-% in the cyclic olefin polymer.
